(19) United States
(12) Patent Application Publication
(10) Pub. No.: US 2020/0363253 A1
(43) Pub. Date: Nov. 19, 2020

(54) Quantitative Material Supply Mechanism

(71) Applicant: King Arthur Industries Co., Ltd., Yongjing Township (TW)

(72) Inventors: Ming-Hao Chen, Yongjing Township (TW); Chia-Ming Chen, Yongjing Township (TW)

(21) Appl. No.: 16/414,822

(22) Filed: May 17, 2019

(51) Int. Cl. G01F 13/00

(52) U.S. Cl. CPC G01F 13/003

(57) ABSTRACT

A quantitative material supply mechanism: an accommodation bucket, a delivery device, an adjustment device, and a quantitative feeding bucket. The accommodation bucket includes an outlet defined on a bottom thereof. The delivery device includes a conveyor belt, a drive roller, a driven roller, and a driving unit. The driving unit is connected with the drive roller and drives the drive roller to rotate, and the drive roller matches with the driven roller to actuate the conveyor belt to rotate. The adjustment device is arranged above the conveyor belt and is located between the accommodation bucket and the turnaround portion. The adjustment device includes two adjusters and two actuation units opposite to the two adjusters respectively. The quantitative feeding bucket is mounted below the turnaround portion of the conveyor belt so as to hold the materials which are delivered by the conveyor belt and drop from the turnaround portion.

### BACKGROUND OF THE INVENTION

### Field of the Invention

The present invention relates to a material supply mechanism, and more particularly to a quantitative material supply mechanism to supply materials exactly.

### Description of the Prior Art

A conventional quantitative material supply mechanism contains an accommodation bucket for accommodating materials, an outlet defined on a bottom of the accommodation bucket, a screw rod fixed on the outlet, and a spiral blade surround the screw rod, such that the materials are supplied by using a rotation travel of the screw rod, and a quantitative supply quantity of the materials is determined by ways of a material supply time.

However, the quantitative supply quantity of the materials cannot be precise by using the screw rod, and the quantitative supply quantity of the materials cannot be determined exactly by ways of a material supply time, thus causing inexact the quantitative supply quantity, unstable product quality, difficult washing of the quantitative material supply mechanism when changing the materials, and time-consuming material change.

The present invention has arisen to mitigate and/or obviate the afore-described disadvantages.

### SUMMARY OF THE INVENTION

The primary objective of the present invention is to provide a quantitative material supply mechanism which supplies materials quantitatively by using a quantitative feeding bucket and a delivery device so as to supply material exactly, wash the quantitative material supply mechanism easily when changing the materials, and change the materials quickly.

To obtain above-mentioned objective, a quantitative material supply mechanism provided by the present invention contains: an accommodation bucket, a delivery device, an adjustment device, and a quantitative feeding bucket.

The accommodation bucket is configured to accommodate materials and includes an outlet defined on a bottom of the accommodation bucket.

The delivery device includes a conveyor belt, a drive roller, a driven roller, and a driving unit. The conveyor belt is annular and surrounds the drive roller and the driven roller, and the conveyor belt passes through the outlet of the accommodation bucket so as to carry the materials dropping from the outlet of the accommodation bucket. The conveyor belt has a turnaround portion formed on an end thereof, the driving unit is connected with the drive roller and drives the drive roller to rotate, and the drive roller matches with the driven roller to actuate the conveyor belt to rotate.

The adjustment device is arranged above the conveyor belt and located between the accommodation bucket and the turnaround portion of the delivery belt. The adjustment device includes two adjusters and two actuation units opposite to the two adjusters respectively, the two actuation units are connected with the two adjusters individually, and the actuation units drive the two adjusters to move close to or away from each other.

The quantitative feeding bucket is mounted below the turnaround portion of the conveyor belt so as to hold the materials which are delivered by the conveyor belt and drop from the turnaround portion. The quantitative feeding bucket controls the two adjusters to close to each other so as to reduce a passing space of the materials and a dropping speed of the materials to the quantitative feeding bucket is reduced. When the weight of the materials in the quantitative feeding bucket reaches a default value, the conveyor belt is controlled to suspend rotation, the quantitative feeding bucket is controlled to feed the materials, and the two adjusters of the adjustment device move away from each other and return back to original positions respectively.

### BRIEF DESCRIPTION OF THE DRAWINGS

FIG. 1 is a perspective view showing the assembly of a quantitative material supply mechanism according to a preferred embodiment of the present invention.

FIG. 2 is a side plan view showing the assembly of the quantitative material supply mechanism according to the preferred embodiment of the present invention.

FIG. 3 is another side plan view showing the assembly of the quantitative material supply mechanism according to the preferred embodiment of the present invention.

FIG. 4 is also another side plan view showing the assembly of the quantitative material supply mechanism according to the preferred embodiment of the present invention.

FIG. 5 is a side plan view showing the operation of the quantitative material supply mechanism according to the preferred embodiment of the present invention.

FIG. 6 is a perspective view showing the assembly of a quantitative material supply mechanism according to another preferred embodiment of the present invention.

FIG. 7 is a side plan view showing the assembly of the quantitative material supply mechanism according to another preferred embodiment of the present invention.

FIG. 8 is a perspective view showing the application of the quantitative material supply mechanism according to the present invention.

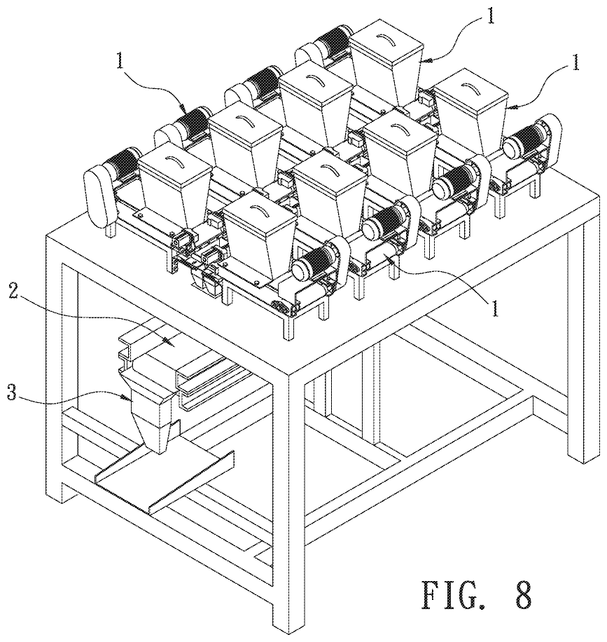

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

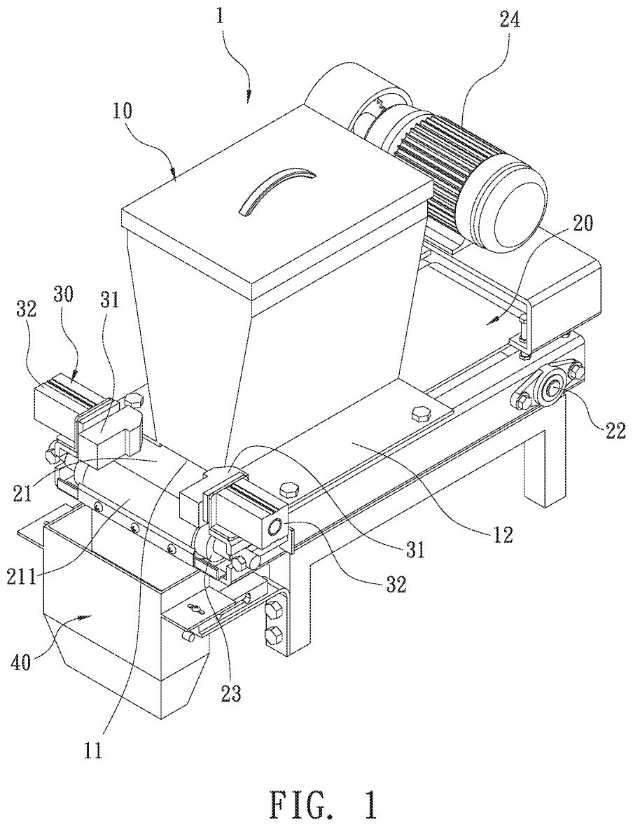

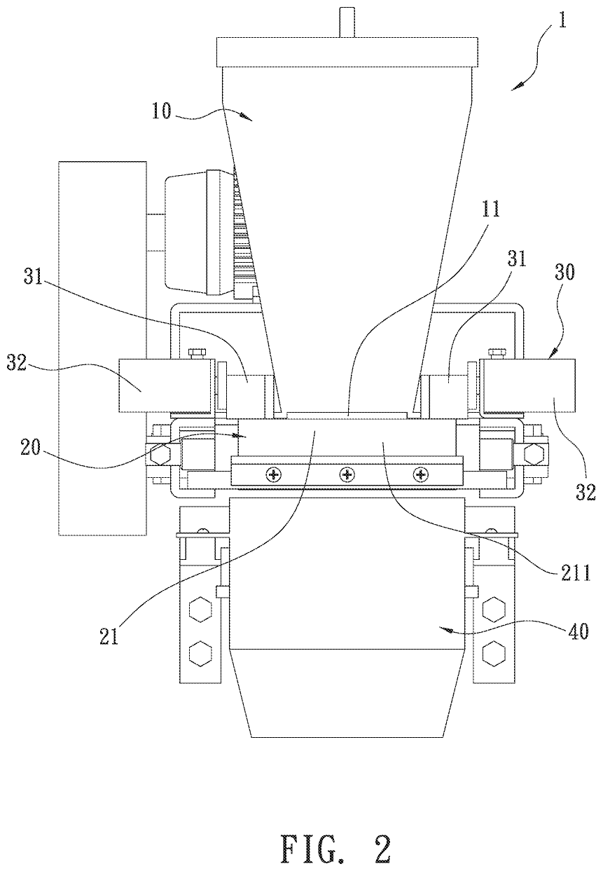

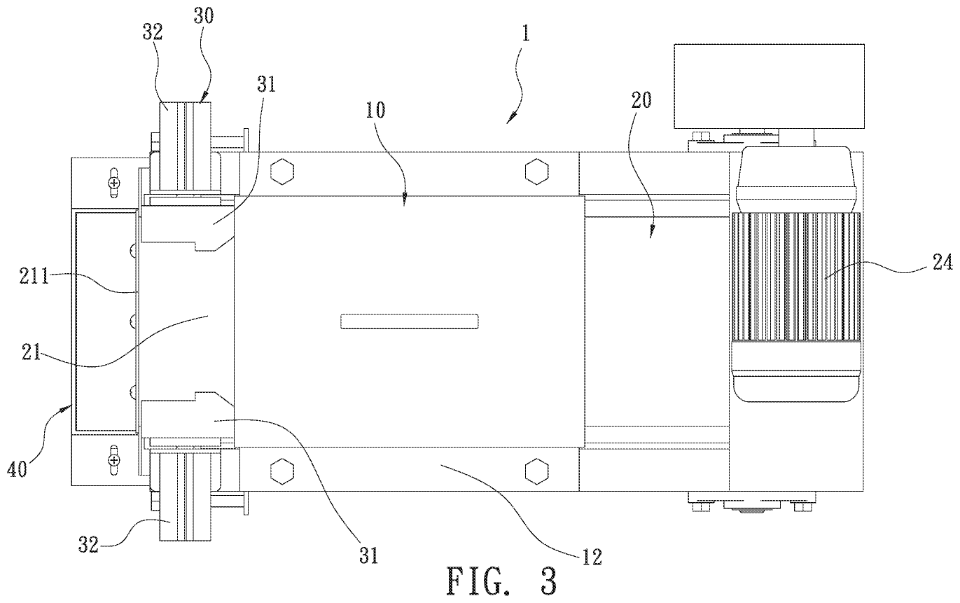

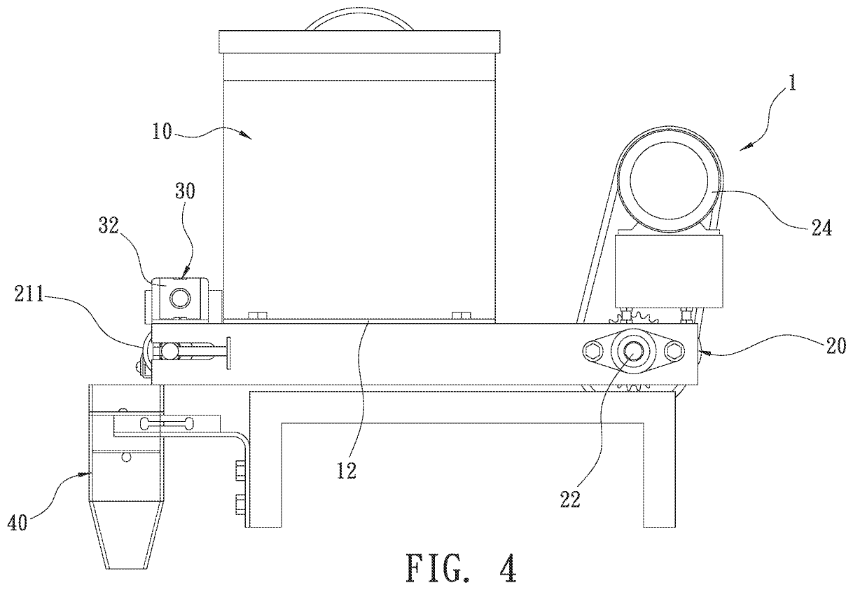

With reference to FIGS. 1-4, a quantitative material supply mechanism 1 according to a preferred embodiment of the present invention comprises: an accommodation bucket 10, a delivery device 20, an adjustment device 30, and a quantitative feeding bucket 40.

The accommodation bucket 10 is conical and hollow so as to accommodate materials, and the accommodation bucket 10 includes an outlet 11 defined on a bottom thereof and a fixing plate 12 extending horizontally from the bottom of the accommodation bucket 10 and configured to lock the accommodation bucket 10.

The delivery device 20 includes a conveyor belt 21, a drive roller 22, a driven roller 23, and a driving unit 24, wherein the conveyor belt 21 is annular and surrounds the drive roller 22 and the driven roller 23, and the conveyor belt 21 passes through the outlet 11 of the accommodation bucket 10 so as to carry the materials dropping from the outlet 11 of the accommodation bucket 10, the conveyor belt 21 has a turnaround portion 211 formed on an end thereof, the driving unit 24 is connected with the drive roller 22 and drives the drive roller 22 to rotate, then the drive roller 22 matches with the driven roller 23 to actuate the conveyor belt 21 to rotate.

The adjustment device 30 is arranged above the conveyor belt 21 and is located between the accommodation bucket 10 and the turnaround portion 211 of the delivery belt 21. The adjustment device 30 includes two adjusters 31 and two actuation units 32 opposite to the two adjusters 31 respectively, wherein the two actuation units 32 are connected with the two adjusters 31 individually. In this embodiment, the two adjusters 31 are two slide blocks individually, the two actuation units 32 are two pneumatic cylinders or two hydraulic cylinders individually, wherein two movable rods of the two pneumatic cylinders or the two hydraulic cylinders are coupled with the two slide blocks individually.

The quantitative feeding bucket 40 is mounted below the turnaround portion 211 of the conveyor belt 21 so as to hold the materials which are delivered by the conveyor belt 21 and drop from the turnaround portion 211, wherein the two actuation units 32 of the adjustment device 30 drive the two adjusters 31 to linearly move close to or away from each other.

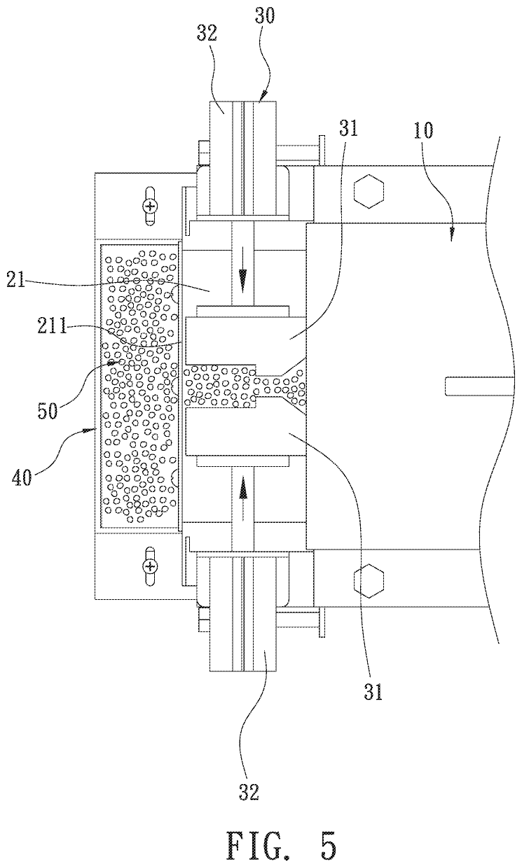

In operation, as shown in FIG. 5, the conveyor belt 21 rotates across a bottom of the outlet 11 of the accommodation bucket 10 so as to carry the materials 50 dropping from the outlet 11 of the accommodation bucket 10, and the materials 50 drop to the quantitative feeding bucket 40 from the turnaround portion 211 of the conveyor belt 21. When a weight of the materials in the quantitative feeding bucket 40 reaches a default value (in this embodiment, the default value is 80% of a loading weight of the quantitative feeding bucket 40), the two actuation units 32 of the adjustment device 30 actuate the two adjusters 31 to linearly move close to each other so as to reduce a passing space of the materials 50 and a dropping speed of the materials 50 to the quantitative feeding bucket 40 is reduced. When the weight of the materials 50 in the quantitative feeding bucket 40 reaches the default value, the conveyor belt 21 suspends rotation, the quantitative feeding bucket 40 is controlled to feed the materials, and the two adjusters 31 of the adjustment device 30 move away from each other and return back to their original positions respectively.

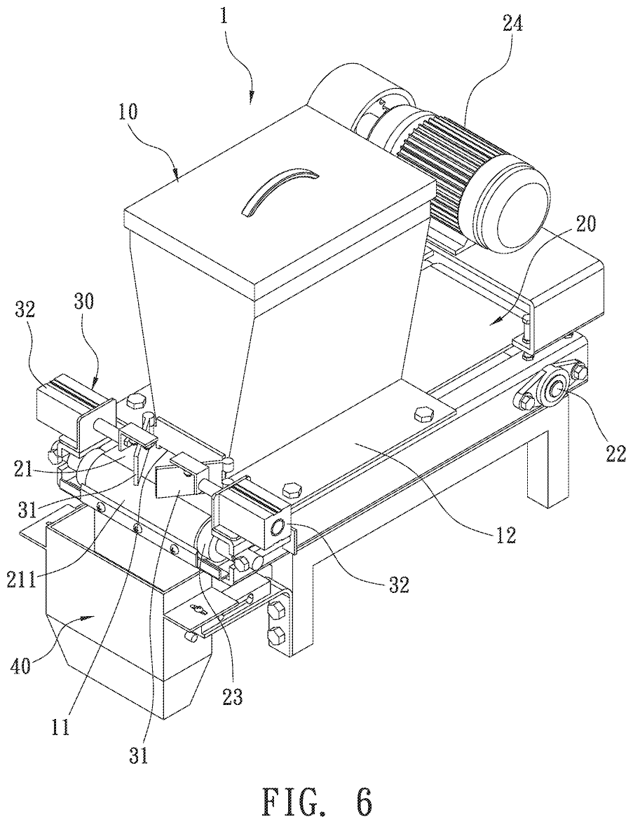

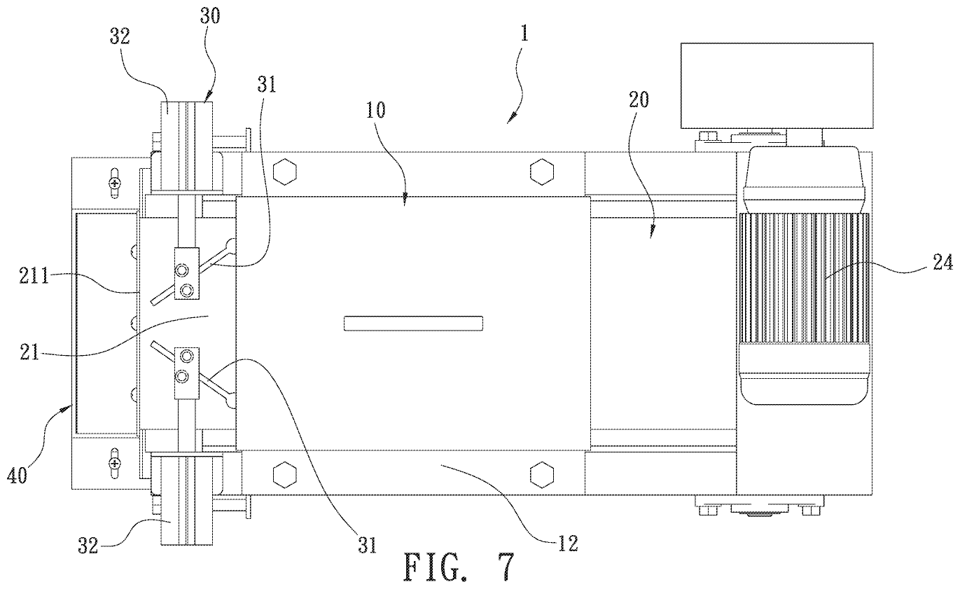

Referring further to FIGS. 6 and 7, in another embodiment, two rotation plates are individually provided to match with the two actuation units 32 which are two pneumatic cylinders or two hydraulic cylinders, wherein two movable rods of the two pneumatic cylinders or the two hydraulic cylinders are coupled with the two rotation plates individually so that the two rotation plates rotate to close to or away from each other. When the weight of the materials in the quantitative feeding bucket 40 is close to the default value, the two actuation units 32 of the adjustment device 30 actuate the two adjusters 31 to rotate close to each other so as to reduce a passing space of the materials 50 and a dropping speed of the materials 50 to the quantitative feeding bucket 40 is reduced. When the weight of the materials 50 in the quantitative feeding bucket 40 is equal to the default value, the conveyor belt 21 suspends rotation, the quantitative feeding bucket 40 is controlled to feed the materials, and the two adjusters 31 of the adjustment device 30 move away from each other and return back to their original positions respectively.

In use, multiple quantitative material supply mechanisms 1 are arranged symmetrically, and a collection delivery device 2 is fixed below the multiple quantitative feeding buckets 40 of the multiple quantitative material supply mechanisms 1 so as to hold the materials 50 dropping from the multiple quantitative feeding buckets 40 of the multiple quantitative material supply mechanisms 1, and the materials are delivered to a collection feeding bucket 3 so as to feed the materials.

Accordingly, the quantitative material supply mechanism has advantages as follows:

The materials 50 are delivered by the conveyor belt 21 of the conveyor 20 so that the materials 50 drops to the quantitative feeding bucket 40, and the quantitative feeding bucket 40 controls the two adjusters 31 of the collection bucket 30 and the conveyor belt 21 of the conveyor 20 to operate, thus supplying the materials quantitatively and exactly, obtaining stable product quality, washing the quantitative material supply mechanism easily, and changing the materials quickly.

While various embodiments in accordance with the present invention have been shown and described, it is clear to those skilled in the art that further embodiments may be made without departing from the scope of the present invention.

What is claimed is:

1. A quantitative material supply mechanism comprising:
an accommodation bucket configured to accommodate materials and including an outlet defined on a bottom of the accommodation bucket;
a delivery device including a conveyor belt, a drive roller, a driven roller, and a driving unit, wherein the conveyor belt is annular and surrounds the drive roller and the driven roller, and the conveyor belt passes through the outlet of the accommodation bucket so as to carry the materials dropping from the outlet of the accommodation bucket, the conveyor belt has a turnaround portion formed on an end thereof, the driving unit is connected with the drive roller and drives the drive roller to rotate, and the drive roller matches with the driven roller to actuate the conveyor belt to rotate;
an adjustment device arranged above the conveyor belt and located between the accommodation bucket and the turnaround portion of the delivery belt, wherein the adjustment device includes two adjusters and two actuation units opposite to the two adjusters respectively, the two actuation units are connected with the two adjusters individually, and the two actuation units drive the two adjusters to move close to or away from each other; and
a quantitative feeding bucket mounted below the turnaround portion of the conveyor belt so as to hold the materials which are delivered by the conveyor belt and drop from the turnaround portion, wherein the quantitative feeding bucket controls the two adjusters to close to each other so as to reduce a passing space of the materials and a dropping speed of the materials to the quantitative feeding bucket is reduced; wherein when the weight of the materials in the quantitative feeding bucket reaches a default value, the conveyor belt is controlled to suspend rotation, the quantitative feeding bucket is controlled to feed the materials, and the two adjusters of the adjustment device move away from each other and return back to original positions respectively.

2. The quantitative material supply mechanism as claimed in claim 1, wherein the accommodation bucket is conical and hollow, and the accommodation bucket includes a fixing plate extending horizontally from the bottom of the accommodation bucket and configured to lock the accommodation bucket.

3. The quantitative material supply mechanism as claimed in claim 1, wherein the two adjusters are two slide blocks individually to linearly move close to or away from each other.

4. The quantitative material supply mechanism as claimed in claim 1, wherein the two adjusters of the adjustment device are two rotation plates individually, and the two rotation plates are driven to rotate close to or away from each other.

5. The quantitative material supply mechanism as claimed in claim 1, wherein the actuation units are pneumatic cylinders or hydraulic cylinders.
